(19) United States
(12) Patent Application Publication
(10) Pub. No.: US 2013/0109214 A1
(43) Pub. Date: May 2, 2013

(54) CARD EDGE CONNECTOR

(71) Applicant: Hsu-Mao CHING, New Taipei City (TW)

(72) Inventor: Hsu-Mao CHING, New Taipei City (TW)

(21) Appl. No.: 13/283,696

(22) Filed: Oct. 28, 2011

(51) Int. Cl. H01R 13/62

(52) U.S. Cl. 439/328

(57) ABSTRACT

A card edge connector includes an insulation housing and two side arms. The insulation housing forms two insertion sections and an insertion slot receiving a plurality of terminals therein. Each side arm includes an arm body, an extension plate, a fixed arm section, and a movable arm section. All bent members (including a retention member, a pushing member, and a stop member) are all integrally formed with the movable arm section. The fixed arm section and the movable arm section of the side arm are arranged not to interfere with each other, so that the side arms show the advantages of being easy to manufacture and having a simplified manufacturing process. Further, the card edge connector has a unique arrangement that helps simplifying the structure thereof and requires no extra or external mounting member so as to achieve the effect of reducing the material used.

### FIELD OF THE INVENTION

The present invention relates to a card edge connector, and in particular to a card edge connector that receive insertion of a card edge of an electronic card therein for electrical connection and mechanical positioning.

### BACKGROUND OF THE INVENTION

A card edge connector functions to receive a card edge of an electronic card (such as a memory card applicable to various computers) to electrically insert therein and at the same time realize mechanical positioning.

A conventional card edge connector, of which an example is shown in Taiwan Utility Model M401900, which discloses an improved fixing structure of electrical connector, comprises a housing forming an insertion slot that has opposite side walls supporting a plurality of terminals; two side arms arranged at opposite ends of the housing, each side arm having an extension plate coupled to the housing, a movable arm section, and a fixed arm section, the extension plate, the movable arm section, and the fixed arm section being combined together as a unitary structure, in which each fixed arm section forming an insertion plate extending downward; and two mounting seats, which are respectively coupled to the side arms, each mounting seat comprising a straight plate and curved plates respectively attached to opposite sides of the straight plate, the curved plates forming therebetween a fitting zone for coupling the insertion plate. After an electronic card is electrically inserted, retention plates of the two movable arm sections respectively engage semi-circular notches defined in opposite sides of the electronic card.

To remove the electronic card, an operator uses fingers to simultaneously forcibly move two pushing members of the conventional card edge connector outward. Stop plates are provided to limit the moved distances of the pushing members.

Although the conventional card edge connector provides the functions of receiving an electronic card to electrically insert therein and realizing mechanical positioning, yet the structure of the conventional card edge connector is complicated and comprises essential parts such as mounting seats to be mounted to an external device. This increases the number of parts and makes it not possible to lower down the cost. Further, all the curved parts, including the retention plates, the pushing members to be pushed by a user's fingers for removal of electronic card, and stop plates, are provided on the fixed arm section and movable arm section and all these retention plates, pushing members, and stop plates are alternately arranged between the fixed arm section and the movable arm section (for example the stop plate of the movable arm section being arranged to extend through the fixed arm section) and induce undesired interference, leading to a drawback of being difficult to manufacture and including a complicated manufacturing process for the conventional side arm, this being adverse to the economical advantages desired by the modern industry. Thirdly, the pushing members have a small surface area, making it not complying with ergonomics when being pushed by fingers for being hard to apply a force thereto, which leads to a common deficiency of being hard to remove the electronic card. Fourthly, the extension plate of the side arm is provided with a serrated surface to tightly and fixedly retain the side arm in a hole defined in the housing and this makes it not possible for position adjustment.

Thus, the present invention aims to provide a card edge connector that overcomes the above discussed problems.

### SUMMARY OF THE INVENTION

An objective of the present invention is to provide a card edge connector that has a unique arrangement for simplifying the structure thereof and eliminating extra or externally mounted parts so that the material used is less than that of a conventional connector to achieve the purpose of cost reduction.

The second objective of the present invention is to provide a card edge connector, of which curved parts (including retention members, pushing members, and stop members) are all integrally formed with a movable arm section and a fixed arm section and the movable arm section of a side arm show on mutual interference so as to provide the advantages that the side arm is easy to manufacture and the manufacturing process thereof is simple, completely complying with the economic performance desired by the modern industry.

The third objective of the present invention is to provide a card edge connector, in which a limiting member is integrally formed with a movable arm section and the limiting member is located between a fixed arm section and a movable arm section of a side arm so that the limiting member and a stop member together limit a movement range of the movable arm section that is pushed outward thereby significantly improving the capability of limiting against the movement range of the movable arm section.

The fourth objective of the present invention is to provide a card edge connector, which comprises a pushing member that, besides showing an increased surface area, provides a shape that is in compliance with ergonomics and is easy to apply a force thereto.

The fifth objective of the present invention is to provide a card edge connector, which comprises an insertion member formed on each side arm, and the insertion member forms a barb section, so as to achieve an effect of showing an improved coupling strength of each side arm inserted into the insulation housing and being not ready to detach.

The fifth objective of the present invention is to provide a card edge connector, which comprises a flat section formed on the insertion section of each side arms and the flat section of the insertion member is set adjacent to an inside wall of the insertion section so as to achieve an effect of minor position adjustment of the insertion of the side arm into the insertion section.

The sixth objective of the present invention is to provide a card edge connector, wherein the insertion member of the side arm is a resilient insertion member, whereby the resilient insertion member is allowed to spring back upward when reaching a predetermined location to have the barb section engaging and thus retained by a retention wall of the insertion section so as to achieve an effect of the side arm being easy insertion and assembling.

To achieve the above objectives, the present invention provides a card edge connector comprising an insulation housing and two side arms. The insulation housing has a surface having opposite two ends each forming an insertion section. An insertion slot is formed in the surface between the two insertion sections. The insertion slot receives a plurality of terminals therein. Each of the side arms comprises an arm body, an extension plate that is formed integrally with and extends rearward from the arm body, and a fixed arm section and a movable arm section that are formed integrally with and project frontward from the arm body. The fixed arm section comprises a soldering leg integrally formed therewith and extending downward. The soldering leg has an end that is bent sideways to form a soldering section. The movable arm section comprises a retention member, a pushing member, and a stop member integrally formed therewith. The extension plate of each of the side arms is inserted into the respective insertion section of the insulation housing. The fixed arm section and the movable arm section of each of the side arms are arranged to not interfere with each other.

As such, the structure is simplified, requiring no extra or external mounting member, so that an effect of reducing cost and the material used is realized. All the bent members (including the retention member, the pushing member, and the stop member) are all integrally formed with the movable arm section. The fixed arm section and the movable arm section are arranged not to interfere with each other, thereby providing an effect of the side arms being easy to manufacture and the manufacturing process being simple, so as to completely comply with the economic advantage desired by the modern industry.

### BRIEF DESCRIPTION OF THE DRAWINGS

The present invention will be apparent to those skilled in the art by reading the following description of preferred embodiments thereof with reference to the drawings, in which:

FIG. 1 is a perspective view of a first embodiment according to the present invention;

FIG. 2 is a perspective view of a side arm of the first embodiment according to the present invention;

FIG. 2A is another perspective view of the side arm of the first embodiment according to the present invention;

FIG. 3 is a partial plan view the first embodiment according to the present invention;

FIG. 4 is a partial cross-sectional view of the first embodiment according to the present invention;

FIG. 5 is a perspective view of a second embodiment according to the present invention;

FIG. 6 is a perspective view of a side arm of the second embodiment according to the present invention; and

FIG. 7 is a partial plan view of the second embodiment according to the present invention.

### DETAILED DESCRIPTION OF THE PREFERRED EMBODIMENTS

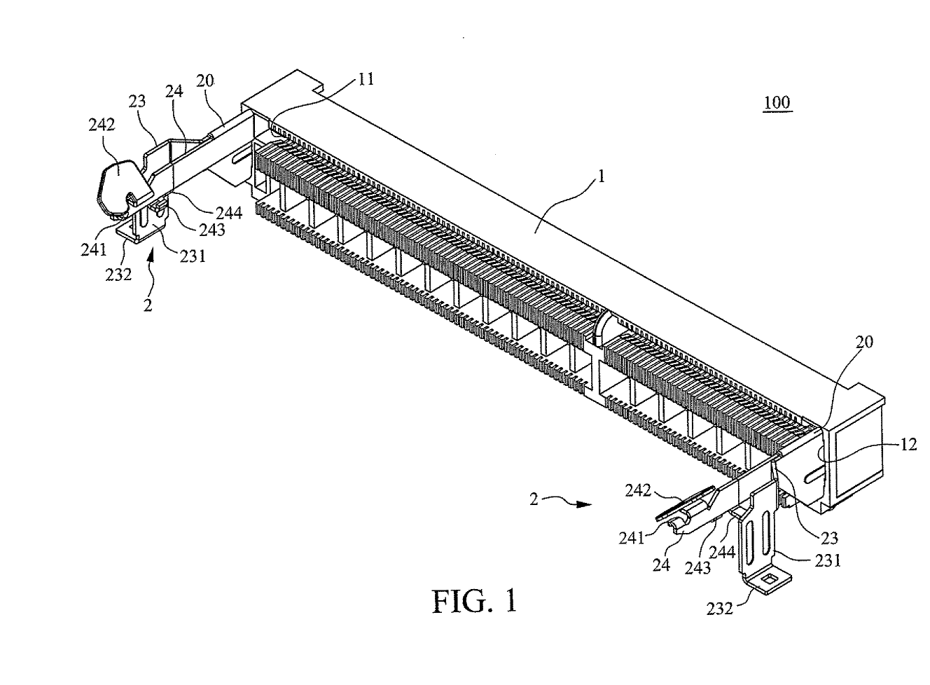

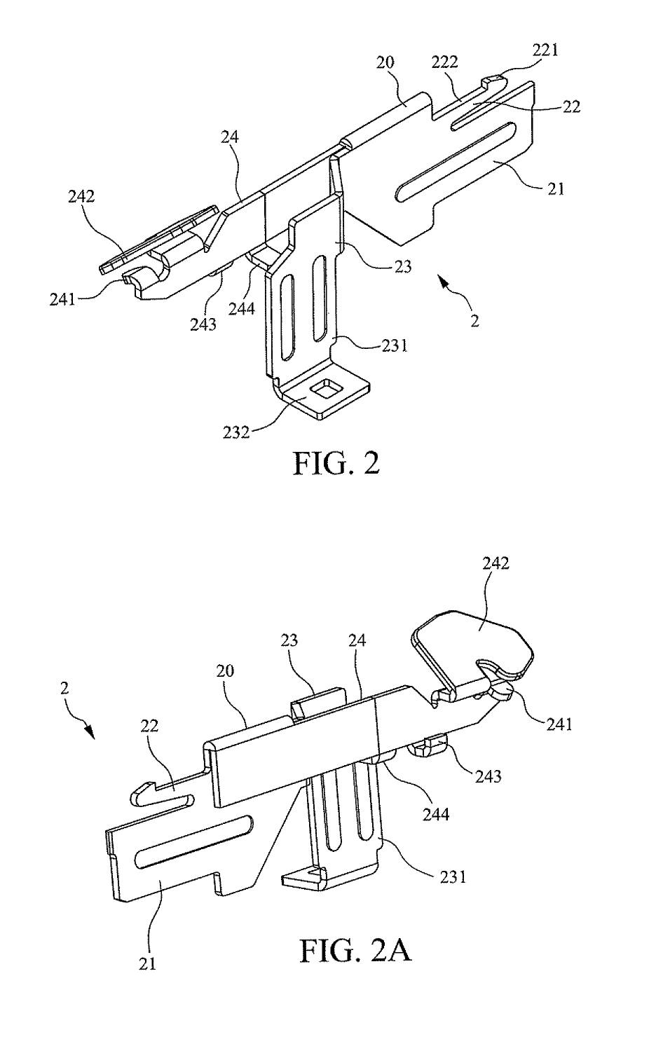

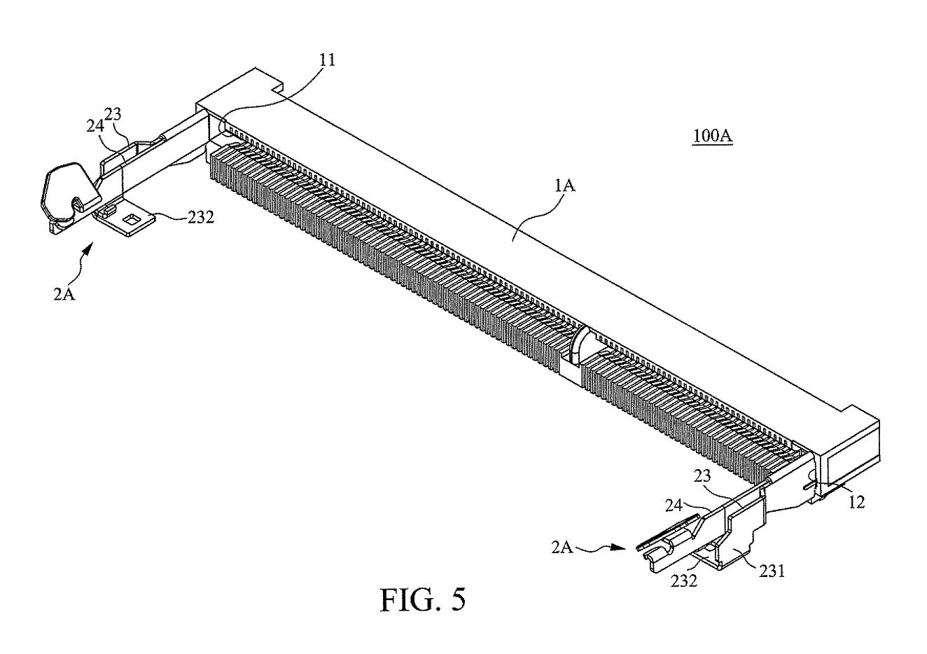

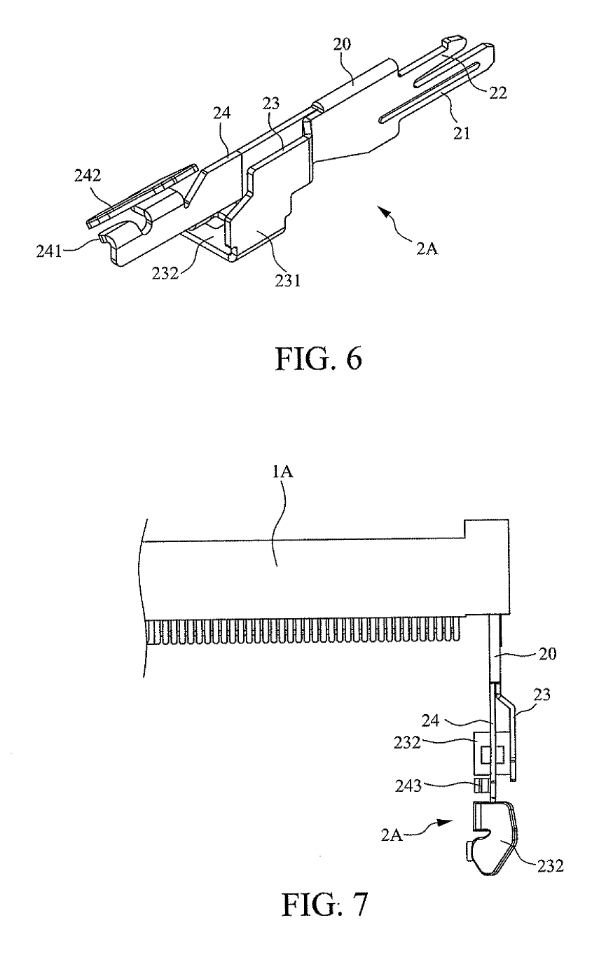

The present invention provides a card edge connector. FIGS. 1-4 of the attached drawings show a first embodiment according to the present invention, and FIGS. 5-7 show a second embodiment according to the present invention.

### First Embodiment

Referring to FIGS. 1-4, the first embodiment of the present invention provides a card edge connector 100, which generally comprises an insulation housing 1 and two side arms 2.

The insulation housing 1 has a surface (which in the embodiment illustrated is a front surface). The surface has two opposite ends each of which is provided with an insertion section 12, and an insertion slot 11 is formed in the surface between the two insertion sections 12. The insertion slot 11 receives a plurality of terminals, which is not shown, arranged therein.

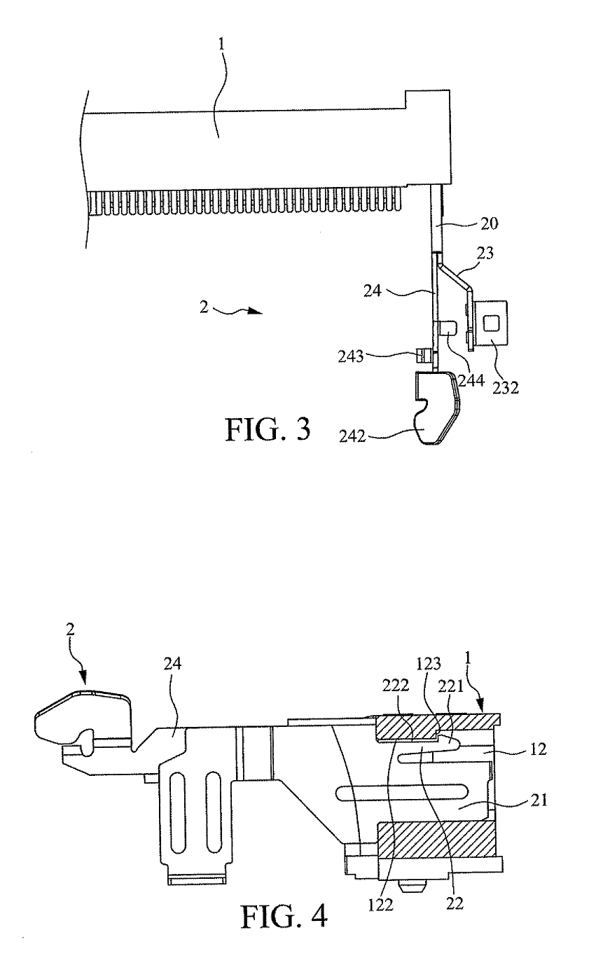

Each of the side arms 2 comprises an arm body 20, an extension plate 21 that is formed integrally with and extends rearward from the arm body, and a fixed arm section 23 and a movable arm section 24 that are formed integrally with and project frontward from the arm body. As shown in the drawings, the fixed arm section 23 comprises a soldering leg 231 integrally formed therewith and extending downward. The soldering leg 231 has a distal end that is bent sideways to form a soldering section 232. As shown in the drawings, the soldering section 232 is formed by being integrally bent sideways from the end of the soldering leg 231. Further, a retention member 241, a pushing member 242, and a stop member 243 (and a limiting member 244 that will be discussed hereinafter) are all integrally formed with the movable arm section 24. Thirdly, as shown in FIG. 3, the fixed arm section 23 and the movable arm section 24 of each one of the side arms 2 are arranged to not interfere with each other. The assembling of the two side arms 2 and the insulation housing 1 is performed by inserting the extension plate 21 of each of the side arms 2 into the respective insertion section 12 of the insulation housing 1.

The movable arm section 24 is bent inwards at an upper edge portion that is adjacent to a free end thereof to respectively and integrally form the retention member 241 and the pushing member 242. The movable arm section 24 is also bent inwards at a lower edge portion thereof to integrally form the stop member 243. The movable arm section 24 is also bent, in an outward direction, at the lower edge thereof to integrally form the limiting member 244. The limiting member 244 is set between the movable arm section 24 and the fixed arm section 23 to limit the distance of an outward movement of the movable arm section 24 because during being pushed outward, the limiting member 244 engages and is thus constrained by the fixed arm section 23.

Further, the arm body 20 of the side arm 2 is rearward extended to integrally form an insertion member 22. The insertion member 22 has a free end forming at least one barb section 221. The insertion member 22 has an upper edge forming a flat section 222. When the extension plate 21 of the side arms 2 is inserted into the insertion section 12 of the insulation housing 1, as shown in FIG. 4, the insertion member 22 is simultaneously fit into the insertion section 12, whereby the barb section 221 of the insertion member 22 catches inside the insertion section 12 to provide the side arm 2 with an effect of showing improved coupling strength and being not ready to detach. The flat section 222 of the insertion member 22 is set adjacent to an inside wall 122 of the insertion section 12, whereby in an attempt to adjust the location of the side arm 2, the flat section 222 that is formed at an upper edge of the insertion member 22 to provide a slidable engagement with the inside wall 122 allows of slight position adjustment of the insertion of the side arms 2 into the insertion section 12. In the embodiment illustrated, the insertion member 22 comprises a spring like resilient member, and the resilient insertion member, when inserted into the insertion section 12 of the insulation housing 1, is caused by the barb section 221 abutting the inside wall 122 to resiliently deflect downward (not illustrated in the drawings). When the insertion reaches a predetermined location, the resilient insertion member spring back upward to have the barb section 221 engage and thus be retained by a retention wall 123 (see FIG. 4) inside the insertion section 12. As such, the side arms 2 are advantageous in easy insertion for assembling.

### Second Embodiment

Referring to FIGS. 5-7, the second embodiment of the present invention provides a card edge connector 100A, which is substantially identical to that of the first embodiment, except that height and some minor structural features of the insulation housing 1A are different from the insulation housing 1 of the first embodiment and the height and a minor portion of the structure of the side arms 2A are different from the side arms 2 of the first embodiment.

As shown in the drawings, the side arms 2A have a height less than the first embodiment and comprise a soldering leg 231 having a shape different from that of the first embodiment. A soldering section 232 is formed by integrally bending the soldering leg 231 in an inward direction (the soldering section of the first embodiment being integrally bent in an outward direction). Further, the side arms 2A comprise no limiting member 244 of the first embodiment.

In summary, the card edge connectors 100, 100A of the first and second embodiments of the present invention show the following advantages. The structure is simplified, requiring no extra or external mounting member, so that the material used is less than the conventional one and an effect of reducing cost can be realized. All the bent members, including the retention member 241, the pushing member 242, and the stop member 243 (the limiting member 244 being also included for the first embodiment) are all integrally formed with the movable arm section 24, and the fixed arm section 23 and the movable arm section 24 of each side arm 2 are arranged not to interfere with each other, thereby providing an effect of the side arms 2, 2A being easy to manufacture and the manufacturing process being simple, so as to completely comply with the economic advantage desired by the modern industry. For the first embodiment, besides using the stop member 243 arranged between the fixed arm section 23 and the movable arm section 24 of each side arm to limit the distance of movement of the movable arm section 24, the limiting member 244 is also helpful in improving the capability of limiting the distance of outward movement of the movable arm section 24. The pushing member 242 has a surface area greater than the conventional one and also has a shape in compliance with ergonomics to allow of easy application of force. With an insertion member 22 additionally formed on the side arm 2, 2A and a barb section 221 formed on the insertion member 22, the side arm 2, 2A, after being inserted into the insulation housing 1, 1A, shows an effect of having improved coupling strength and being not ready to detach. With a flat section 222 formed on the insertion member 22 and the flat section 222 being set adjacent to an inside wall 122 of the insertion section 12, an effect of minor position adjustment of the insertion of the side arm 2, 2A into the insertion section 12 is achieved. With the insertion member 22 being a resilient insertion member, the resilient insertion member is allowed to spring back upward when reaching a predetermined location to allow a barb section 221 to resiliently engage and thus retained by a retention wall 123 inside the insertion section 12 so as to ensure easy insertion and assembling of the side arm 2.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A card edge connector, comprising:
an insulation housing, which has a surface having opposite two ends each forming an insertion section, an insertion slot being formed in the surface between the two insertion sections, the insertion slot receiving a plurality of terminals therein; and
two side arms, each of which comprises an arm body, an extension plate that is formed integrally with and extends rearward from the arm body, and a fixed arm section and a movable arm section that are formed integrally with and project frontward from the arm body, the fixed arm section comprising a soldering leg integrally formed therewith and extending downward, the soldering leg having an end that is bent sideways to form a soldering section, the movable arm section comprising a retention member, a pushing member, and a stop member integrally formed therewith, the extension plate of each of the side arms being inserted into the respective insertion section of the insulation housing, the fixed arm section and the movable arm section of each of the side arms being arranged to not interfere with each other.

2. The card edge connector as claimed in claim 1, wherein the movable arm section is bent inwards at an upper edge portion that is adjacent to a free end thereof to respectively and integrally form the retention member and the pushing member, the movable arm section being bent inwards at a lower edge portion thereof to integrally form the stop member.

3. The card edge connector as claimed in claim 1, wherein the movable arm section comprises a limiting member integrally formed therewith, the limiting member being located between the movable arm section and the fixed arm section.

4. The card edge connector as claimed in claim 3, wherein the movable arm section has a lower edge that is integrally bent outward to form the limiting member.

5. The card edge connector as claimed in claim 1, wherein the soldering section is formed by being integrally bent sideways from the end of the soldering leg.

6. The card edge connector as claimed in claim 1, wherein the soldering section is formed by being integrally bent sideways from the end of the soldering leg.

7. The card edge connector as claimed in claim 1, wherein the arm body of each of the side arms is rearward extended to integrally form an insertion member, the insertion member having a free end forming at least one barb section, the insertion member being inserted into the respective insertion section of the insulation housing with the barb section catching inside the insertion section.

8. The card edge connector as claimed in claim 7, wherein the insertion member of the side arm has an upper edge forming a flat section, the flat section of the insertion member being set adjacent to an inside wall of the insertion section.

9. The card edge connector as claimed in claim 7, wherein the insertion member of the side arms is a resilient insertion member, the resilient insertion member being resiliently inserted into the insertion section of the insulation housing with the barb section of the resilient insertion member engaging and thus being retained by a retention wall of the insertion section.

10. The card edge connector as claimed in claim 8, wherein the insertion member of the side arms is a resilient insertion member, the resilient insertion member being resiliently inserted into the insertion section of the insulation housing with the barb section of the resilient insertion member engaging and thus being retained by a retention wall of the insertion section.
